(19) United States
(12) Patent Application Publication
(10) Pub. No.: US 2005/0251334 A1
(43) Pub. Date: Nov. 10, 2005

(54) Electronic device having map display function and program for the same

(76) Inventor: Tomoaki Mizuno, Toyoake-city (JP)

Correspondence Address: POSZ LAW GROUP, PLC, 12040 SOUTH LAKES DRIVE, SUITE 101, RESTON, VA, 20191, US

(21) Appl. No.: 11/110,827

(22) Filed: Apr. 21, 2005

(30) Foreign Application Priority Data
Apr. 21, 2004 (JP) 2004-125727

(51) Int. Cl. G01C 21/30

(52) U.S. Cl. 701/209; 701/211

(57) ABSTRACT

A vehicle navigation system 1 includes a control unit that performs control for displaying a map and marks indicating points of interest based on map data and points of interest data read from a map data input unit. The control unit performs control for displaying icons indicating points of interest in three different sizes according to additional information values. The control unit determines the additional information values based on the points of interest data including sizes, the number of years since opening or renovation, evaluations by the third party, and price ratings of the points of interest. Therefore, a user can obtain information on locations of points of interest and additional information from the icons. Namely, the navigation system 1 provides information that is helpful for the user in searching points of interest that the user wants to go.

### CROSS REFERENCE TO RELATED APPLICATION

This application is based on and incorporates herein by reference Japanese Patent Application No. 2004-125727 filed on Apr. 21, 2004.

### FIELD OF THE INVENTION

The present invention relates to an electronic device having a map display function and a program for the electronic device.

### BACKGROUND OF THE INVENTION

A vehicle navigation system has a function for displaying surrounding points of interest, such as convenience stores, service stations, and restaurants, on a road map. More specifically, an icon is prepared for each point of interest and displayed in its location on the map. A user can obtain information on a kind and a location of a point of interest from an icon displayed on the map. A vehicle navigation system of such a kind is proposed in JP-A-2004-69561.

In the navigation system, a common icon representing multiple points of interest is displayed when the points of interest are densely packed in a display area. For example, a number of convenience stores are located in a small area in cities and icons indicating the convenience stores may overlap each other at certain scales of the map. As a result, a user may not recognize the icons and names of road and places displayed on the map. The common icon is a solution for such a problem.

However, the common icon cannot provide information on scales of the points of interest, which are useful pieces of information for searching a store in an unfamiliar area. For example, a user may end up arriving at a small hardware store even he or she is searching a large hardware store, such as a home improvement store, if information on sizes of stores is not provided. Namely, the navigation system only provides kinds and locations of points of interest.

### SUMMARY OF THE INVENTION

The present invention therefore has an objective to provide an electronic device having a map display function, which displays marks indicating points of interest in a manner that a user can obtain information on the points of interest from the marks. An electronic device of the present invention includes data storing means and display control means.

The data storing means stores map data and points of interest data that is data on points of interest exist in an area of a map. The display control means performs control for displaying a map and marks indicating points of interest based on the map data and the points of interest data read from the data storing means. The points of interest data includes priority information indicating priority levels of points of interest in a kind for display. The display control means alters display attributes of the points of interest so that the marks of the points of interest are displayed in a manner that the priority levels are noticeable.

The marks may be prepared in different styles so that the user can obtain information on the points of interest from the marks. However, a large number of styles may be required. Moreover, alteration to the priority levels may be required when the number of points of interest changes. For example, the priority levels may be changed from two to three or four as the number of the points of interest increases. In this case, the marks have to be reproduced. The electronic device of the present invention changes the styles of the marks only by altering the display attributes. Thus, the reproduction of the marks is not necessary.

A program of the present invention for displaying a map and marks indicating points of interest on a display includes reading map data and points of interest data, obtaining priority information, and altering attributes of points of interest. The map data including data on maps and points of interest data including data on the points of interest that exist in areas of the maps are read from a data storing means. The priority information indicating priority levels of the points of interest in a kind is obtained. The attributes of the points of interest are altered so that the marks are displayed in a manner that the priority levels are noticeable.

The program is stored on a storage medium, such as a flexible disk, a magneto-optical disk, a CD-ROM, a hard disk drive, a ROM, and a RAM, and loaded to a computer as necessary. The computer executes the program. The program may be loaded to the computer via a network.

### BRIEF DESCRIPTION OF THE DRAWINGS

The above and other objectives, features and advantages of the present invention will become more apparent from the following detailed description made with reference to the accompanying drawings. In the drawings:

FIG. 1 is a block diagram of a vehicle navigation system according to an embodiment of the present invention;

FIG. 2 is an explanatory diagram of map data according to the embodiment;

FIG. 3 is an explanatory diagram showing relationships between additional information categories and additional information values, and application examples according to the embodiment;

FIG. 4A is an explanatory diagram showing examples of icons displayed in different sizes according to the embodiment;

FIG. 4B is an explanatory diagram showing examples of a display of the electronic device at different scales according to a prior art;

FIG. 4C is a an explanatory diagram showing examples of a display of the electronic device at different scales according to the embodiment;

FIG. 5 is a flowchart showing a map display process according to the embodiment;

FIG. 6 is a flowchart showing an icon display process according to the embodiment;

FIG. 7A is an explanatory diagram showing examples of icons displayed in different sizes according to a modified embodiment; and

FIG. 7B is a flowchart showing steps alternative to steps included in the icon display process shown in FIG. 6 according to a modified embodiment.

### DETAILED DESCRIPTION OF THE PREFERRED EMBODIMENT

The preferred embodiments of the present invention will be explained with reference to the accompanying drawings. In the drawings, the same numerals are used for the same components and devices.

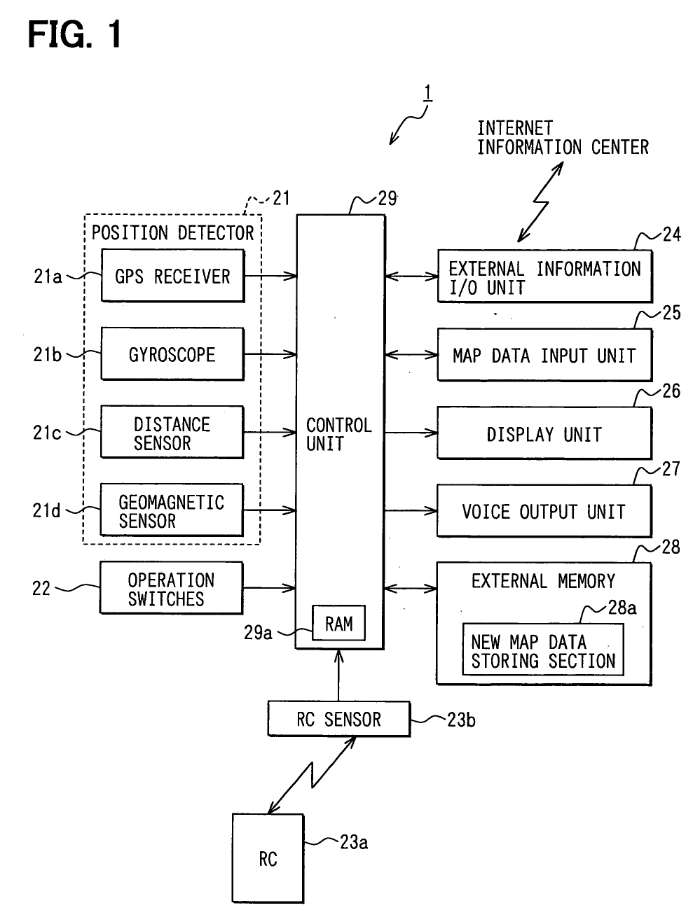

Referring to FIG. 1, a navigation system 1 includes a position detector 21, operation switches 22, a remote control terminal (RC) 23a, a remote control (RC) sensor 23b, an external information input and output (I/O) unit 24, a map data input unit 25, a display unit 26, a voice output unit 27, an external memory 28, and a control unit 29. The position detector 21 detects a current position of a vehicle. The operation switches 22 inputs instructions from a user. The RC 23a also inputs instructions from the user. The RC sensor 23b inputs signals transmitted from the RC 23a to the control unit 29.

The map data input unit 25 reads data including map data and information from an external storage medium and inputs to the control unit 29. The display unit 26 displays a map and a TV program. The voice output unit 27 outputs voice guidance. The external memory 28 stores data. The control unit 29 performs various kinds of processes based on inputs from the position detector 21, the operation switches 22, the RC 23a, the I/O unit 24, the map data input unit 25, and the external memory 28. The control unit 29 controls the position detector 21, the operation switches 22, the RC sensor 23b, the I/O unit 24, the map data input unit 25, the display unit 26, the voice output unit 27, and the external memory 28.

The position detector 21 includes a global positioning system (GPS) receiver 21a, a gyroscope 21b, a distance sensor 21c, and a geomagnetic sensor 21d. The GPS receiver 21a receives signals from a satellite of the GPS via a GPS antenna for detecting a current position of the vehicle. The gyroscope 21b detects the amount of rotary movement of the vehicle. The distance censor 21c detects a travel distance of the vehicle. The geomagnetic sensor 21d detects a travel direction of the vehicle using the geomagnetism. The GPS receiver 21a, the gyroscope 21b, the distance sensor 21c, and the geomagnetic sensor 21d have different kinds of errors, and therefore they are configured to complement each other. Only some of them may be used depending on the accuracy. A steering angle sensor or wheel angle sensors may be used.

The operation switches 22 are touch panel switches integrally provided with the display unit 26 and mechanical key switches provided around the display unit 26. The touch panel switches are provided in a layer of a display panel of the display unit 26. Pressure sensitive switches, electromagnetic induction type switches, capacitance type switches, or combination of those may be used for the touch panel switches.

The I/O unit 24 receives FM broadcasting signals via a radio antenna (not shown). It also receives radio beacon signals and optical beacon signals from fixed stations of vehicle information service systems. The information received by the I/O unit 24 is transmitted to the control unit 29 and processed. The I/O unit 24 can be connected to a mobile phone for receiving information from information centers (not shown) and to the internet for receiving information from servers on the internet.

The map data input unit 25 reads data stored in storage devices, including CD-ROMs, DVD-ROMs, hard disk drives, memories, and memory cards. The data includes road data, which is network data, map data for map matching, points of interest data, and image data and voice data for guidance.

The display unit 26 is a color display unit, such as a liquid crystal display, a plasma display, and a CRT. A current position mark, a guiding route, names, landmarks, and icons are displayed on the display screen of the display unit 26. The current position mark is displayed at a position determined based on a current position detected by the position detector 21 and the map data read by the map data input unit 25. The icons are marks indicating points of interest.

The voice output unit 27 outputs voice guidance based on the image data and the voice data for guidance read by the map data input unit 25. The external memory 28 has a new map data storing section 28a for storing new map data. The new map data may be received from an information center via the I/O unit 24.

The control unit 29 includes a known microcomputer having a CPU, a ROM, a RAM 29a, an I/O, and bus lines for connecting these components. The control unit 29 executes a program stores in the ROM, and calculates coordinates and a travel direction for indicating a current position based on sensor signals from the position detector 21. It performs a process for displaying an area of map containing the current position read by the map data input unit 25 or specified through operation of the operation switches 22 or the RC 23a on the display unit 26.

The control unit 29 also performs a process for providing route guidance. In this process, the control unit 29 selects a target point (destination) based on point data read by the map data input unit 25 and data inputted by the user via the operation switches 33 and the RC 23a. Then, it automatically calculates an optimum route from the current position to the destination. The Daijkstra method may be used for automatically calculating the optimum route. The new map data stored in the new map data storing section 28a is used in the map display process, the optimum route calculation, and the route guidance process.

The storage medium loaded in the map data input unit 25 and the new map data storing section 28a correspond to data storing means. The control unit 29 corresponds to display control means.

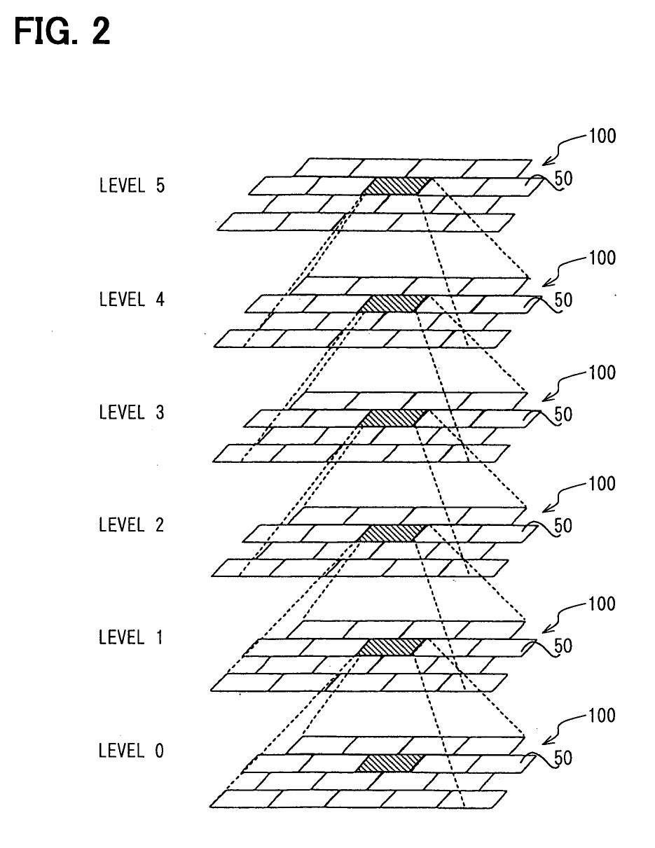

A hierarchy structure of map data 100 is shown in FIG. 2. The map data 100 is generated with levels 5 to 0 and stored. Area map data 50 at level 5 contains information on the largest area of the map among all levels. More specifically, the area map data 50 contains only geographic data. Area map data 50 at level 4 contains information on the second largest area of the map. More specifically, the area map data 50 contains geographic data and freeway data. Area map data 50 at level 3 contains information on the third largest area of the map. More specifically, the area map data 50 contains geographic data, national highway data, and highway data.

Area map data 50 at level 2 contains information on the fourth largest area of the map. More specifically, the area map data 50 contains geographic data, freeway data, national highway data, and prefectural highway data. Area map data 50 at level 1 contains information on the fifth largest area of the map. More specifically, the area map data 50 contains geographic data, freeway data, national highway data, prefectural highway data, and city road data. Area map data 50 at level 0 contains information on the smallest area of the map. More specifically, the area map data 50 contains geographic data, freeway data, national highway data, prefectural highway data, city road data, and street data. The area map data 50 at level 0 contains the most detailed information.

The road data contained in the map data includes information on nodes, such as intersections, and links that connect the nodes. The nodes and the links form a map. Link information is included in the road data. The link information includes link identification numbers (link IDs), and x and y coordinates at a start point and an end point, a road width, a road category, and a road ID of each link. The road category indicates a kind of the road, for instance, a toll road. The road ID identifies the road. Information on names of places, traffic, and points of interest with x and y coordinates is also included in the map data. The geographic data may be image data.

The points of interest data contains information on points of interest that can be displayed on the map. The information includes kinds, additional information, names, and coordinates (latitudes and longitudes). The kinds include large facilities in which buildings are present, such as airport, golf course, and park, medium facilities, such as hotel, hospital, city hall, and library, and small facilities, such as automatic teller machine (ATM), restaurant, service station, and parking.

The additional information data includes additional information attributes (fixed, unfixed), additional information categories (floor areas, with or without parking lots), additional information values, and additional information references (values and equations used for calculations). The additional information attributes specifies display conditions of the icons. The additional information values indicate priority levels of points of interest in the same category for display, and three values, which are large, medium, and small values, are used for the additional information values.

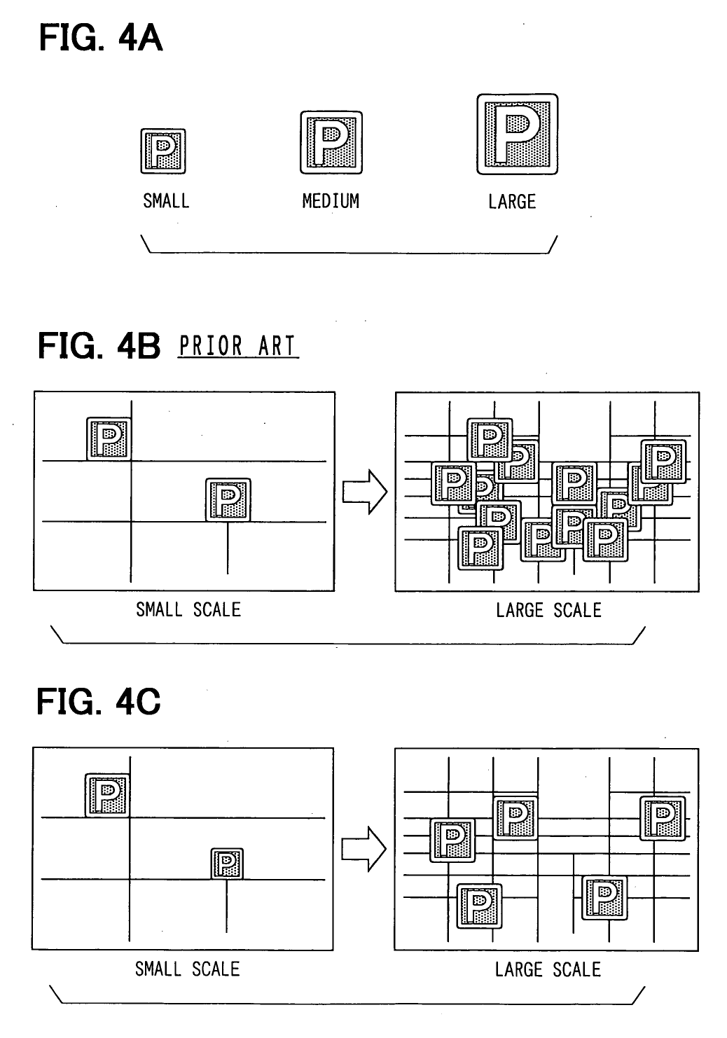

The control unit 29 varies the additional information attributes such that the priority levels are the icons are displayed in different sizes based on the additional information values. The icons are displayed in a large size, a medium size, and a small size as shown in FIG. 4A when the additional information values are the large value, the medium value, and the small value, respectively.

The additional information categories include floor areas of stores, parking lots, capacities of parking lots, the numbers of years since opening or renovation of stores, evaluations by the third party, price ratings, and levels of recommendation as a tourist site. Each of the above categories will be briefly discussed.

The floor areas of stores are classified into three levels: large, medium, and small. The large, the medium, and the small levels are matched with the large, the medium, and the small additional information values. This classification can be applied to stores, eating and drinking places, and hotels. The eating and drinking places can be included in a store group. However, the eating and drinking places are preferable to be in a group different from the store group for providing price rating information. The stores include not only regular stores, such as department stores, supermarkets, and specialty stores, but also pay parking lots. The pay parking lots and the hotels can be classified based on the capacities.

The parking lots and the capacities of parking lots included in the categories are used for classifying the stores based on whether the stores have parking lots, or the capacities of parking lots. The parking lots are classified into three groups: the capacity of five parking spaces or more, the capacity of less than five parking spaces, and no parking lot. The three groups are matched with the large, the medium, and the small additional information values. This classification can be applied to stores, eating and drinking places, and hotels.

The numbers of years since opening or renovation of stores are classified into three groups: less than one year, between one year and five years, and more than five years. The less than one year group, the between one year and five years group, and the more than five years group are matched with the large, the medium, and the small additional information values, respectively. This classification can be applied to stores, eating and drinking places, and hotels.

The less than one year group, the between one year and five years group, and the more than five years group can be matched with the small, the medium, and the large additional information values, respectively. In this embodiment, the less than one year group is matched with the large additional information value so that the icons of newer stores are displayed in large size.

The evaluations by the third party are classified into three groups: high, fair, and poor or no evaluation. The high group, the fair group, and the poor or no evaluation group are matched with the large, the medium, and the small additional information values, respectively. This classification can be applied to stores, eating and drinking places, and hotels.

The price ratings are classified into three groups: high, fair, and low. The high group, the fair group, and the low group are matched with the large, the medium, and the small additional information values, respectively. This classification can be applied to eating and drinking places, hotels, and service stations.

With the above-described configurations, the icons are displayed in different sizes based on the additional information categories. As a result, the user can visually obtain information on points of interest from their respective icons. This is helpful for selecting a target point, or a destination.

The map data input unit 25 reads map data from a storage medium. The map data is produced from map source data stored in map source database (DB). The map source DB is produced by a map production company and shipped to an information center. The information center produces CD-ROMs of the current year edition map when the current edition of the map source DB arrives. Arrangements are made to the original map data by deforming shapes and removing some of shape coordinate matrixes when the current year edition map is produced. The CD-ROMs are put on a regular distribution route and used in the navigation system 1.

The current year edition map source DB is compared with the previous year edition map source DB at the information center when the current year edition map source DB is received. Difference data, which is added, deleted, or modified data, is extracted through the comparison and new map data for updating or upgrading the map data from year XX edition map data to year YY edition map data is produced based on the difference data. The new map data is stored in a new map data DB. The new map data includes map data and points of interest data for updating or upgrading the map data.

Update of the map data and the points of interest data will be discussed. The navigation system 1 sends a request to the information center for new map data. The information center requests the navigation system 1 for uploading information on an edition of the map data and month and date of the new map data that the navigation system 1 has. The information center selects and sends appropriate new map data for updating the map data and the points of interest data to the latest edition to the navigation system 1.

The information center can send all kinds of new map data to the navigation system 1 without the upload of the information. In this case, the information center assumes that the navigation system 1 has the oldest map data. The information center can send the latest new map data to the navigation system 1. In this case, the information center assumes that the navigation system 1 has the latest map data. The navigation system determines whether the received data is proper for updating the map data to the latest edition. If the received data is not proper, the navigation system 1 sends a request for sending new map data, which is the previous new map data. The navigation system 1 repeats the determination and the request transmission until the map data is updated to the latest edition.

The navigation system 1 receives the new map data from the information center via the external information I/O unit 24, and stores in the new map data storing section 28a. It uses the data read from the map data input unit 25 and the data stored in the map data storing section 28a when the map data and the points of interest data are necessary for displaying a map or providing route guidance.

The icons shown in FIG. 4A indicate parking lots. Each icon contains letter P inside a box. The large icon, the medium icon, and the small icon indicate a large parking lot, a medium parking lot, and a small parking lot, respectively. For the parking lots belong to stores, the large icon indicates a parking lot having the capacity of five parking spaces or more. In the same manner, the medium and the small icons indicate a parking lot having the less-than-five parking spaces and no parking lot, respectively. The sizes of the icons are specified by the additional information attributes.

Sample displays of the prior art are shown in FIG. 4B. The icons indicating parking lots are displayed in the same size on the screen. Namely, they only show locations of the parking lots. Two icons are displayed in a small-scale map and thirteen icons are displayed in a large-scale map. The icons overlap each other and cover large areas of roads in the large-scale map. The map becomes hard to read.

Sample displays of the display unit 26 are shown in FIG. 4C. Two icons indicating parking lots are displayed in different sizes on the screen. The large icon indicates a large parking lot and the small icon indicates a small parking lot. The user can obtain information on the sizes of the parking lots from the icons and select a parking lot based on the information. Only large icons indicating large parking lots are displayed on a large-scale map. In this sample, only five icons are displayed on a large-scale map. Thus, the icons do not overlap each other and they only cover small areas of roads. Namely, the map is still easy to read.

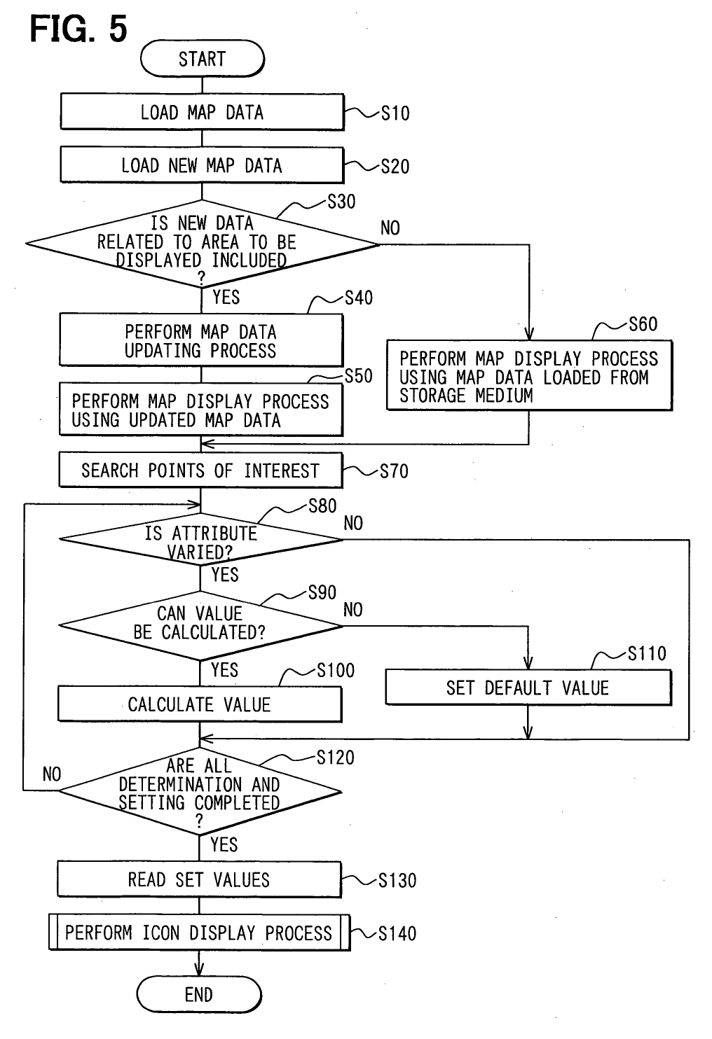

The control unit 29 performs process for displaying a map, calculating a guide route, and providing guidance based on the map data obtained via the map data input unit 25 and new map data obtained via the new map data storing section 28a. The process for displaying a map will be discussed referring to FIG. 5.

The map data of an area of map for display is loaded from the storage medium to the RAM 29a via the map data input unit 25 (S10). The new map data is loaded from the new map data storing section 28a to the RAM 29a (S20). The control unit 29 determines whether new data related to the area to be displayed is included in the data loaded from the storage medium in step S10 (S30). If yes, the control unit 29 performs a process for updating the map data using the new map data (S40). This process is performed for each level (level 5 through 0) shown I FIG. 2 if the new map data is present. The control unit 29 performs the map display process using the updated map data (S50).

If the new map data is not included (no at step S30), the control unit 29 performs the map display process using the map data loaded from the storage medium (S60). The control unit 29 searches points of interest in the displayed area of the map using the updated map data when the map data is updated, or using the map data loaded from the storage medium when the map data is not updated (S70).

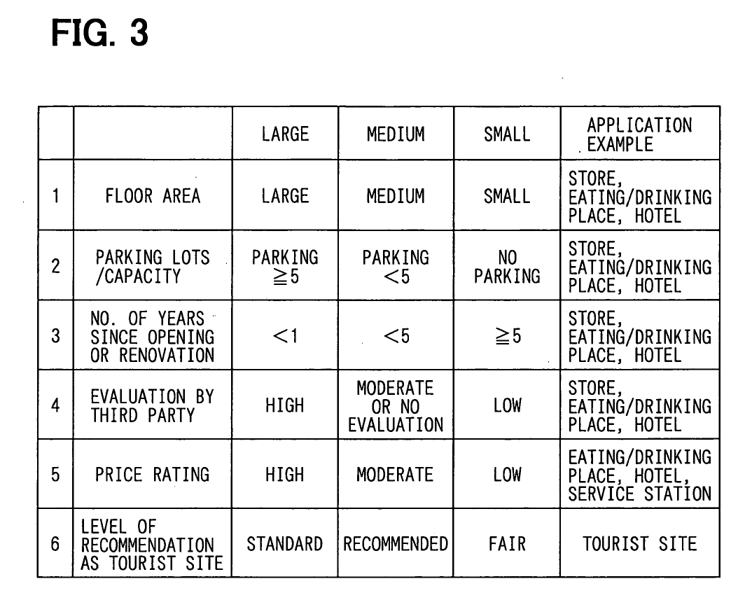

The control unit 29 determines whether the additional information attribute is varied (S80). If yes, it determines the additional information value can be calculated (S90). If yes, it calculates and sets the additional information value (S100). The additional information value is set according to conditions predetermined for each additional information category as shown in FIG. 3. Thus, the control unit 29 determines the additional information value can be calculated based on whether information that satisfies the conditions is present. In the case of calculating the additional information value based on the numbers of years since opening or renovation of stores, the additional information value cannot be calculated if the number of years is unknown. Therefore, the control unit 29 sets a default value for the additional information valued if the additional information value cannot be calculated (S110). The default value can be any one of the large, the medium, and the small values although the medium or the small value is preferable.

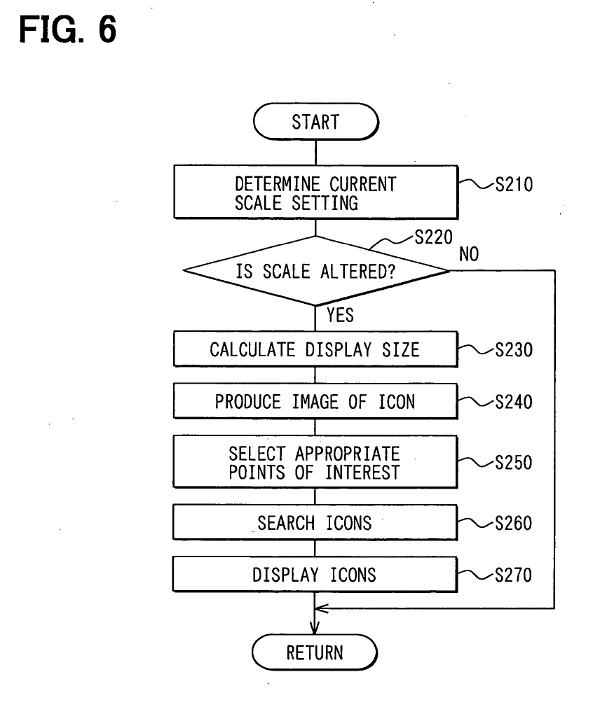

The control unit 29 performs the determination and the setting for each point of interest (S80 through S110) and determines whether the determination and the setting are all completed (S120). If yes, the control unit 29 reads the set additional information values (S130) and performs a process for displaying the icons (S140). The icon display process will be discussed more in detail referring to FIG. 6.

The control unit 29 determines the current scale setting of the map (S210) and determines whether the scale is altered from the previous setting (S220). If yes, the control unit 29 calculates a display size of the icon appropriate for the current scale setting (S230). The scale setting can be altered at multiple steps. Thus, the control unit 29 calculates the display size of the icon so that the icon is displayed in an appropriate size according to the scale setting. The display size of the icon becomes relatively small as the scale becomes small.

Map components are displayed in relatively small sizes when the map is displayed at a small scale, namely, a component indicating a point of interest covers a relatively small area of the map. Therefore, the icon indicating the point of interest is preferable to be displayed in a relatively small size to maintain well-balanced to the map. The number of icons displayed on the map becomes relatively large at a small scale. Thus, the icons are preferable to be displayed in relatively small sizes for better views. A table indicating relationships between the scales and the display sizes may be prepared and the display sizes of the icons may be determined according to the table. Alternatively, the display sizes may be determined using a predetermined equation.

The control unit 29 produces an image of the icon based on the calculated display size (S240). The control unit 29 selects appropriate points of interest for the current scale setting (S250). A number of the icons will be displayed in an area including many points of interest and large areas of the roads on the map will be covered by the icons. As a result, the user may not be able to recognize the location of the target point or the guide route to the target point. Especially, the icons may cover considerable areas of the map at the large scales. Thus, the control unit 29 selects points of interest for display to solve such a problem.

The control unit 29 stores a table that indicates relationships between the scale settings and the additional information values of the points of interest, and selects points of interest for display based on the table. For example, it selects points of interest having the large additional information values for a certain scale, and points of interest having the large and the medium additional information values for another scale. The control unit 29 searches the icons for the points of interest having the determined additional information values (S260), and displays the icons (S270).

The navigation system 1 displays icons indicating points of interest in three different sizes based on the additional information values. Therefore, the user can obtain information on locations of points of interest and additional information from the icons. Namely, the navigation system 1 provides information that is helpful for the user in searching points of interest that the user wants to go. Moreover, the icon sizes increase according to the sizes of the points of interest. Thus, the user can understand that the points of interest indicated with large icons are relatively large facilities.

The navigation system 1 only displays the icons indicating points of interest having the large additional information values, for example, parking lots having large capacities when many points of interest in the same category exist in the displayed area. As a result, the user can easily read the displayed map even in such a case.

### Modified Embodiment

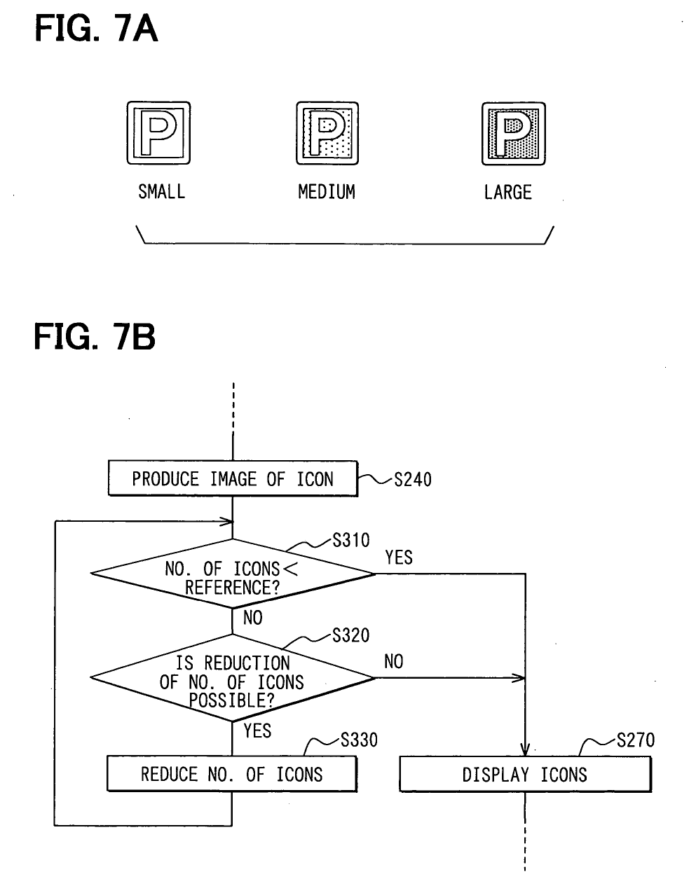

Referring to FIG. 7A, the icons indicating parking lots are displayed in different color or different color tones according to the additional information values. The icons are easily distinguished from others when they are displayed in different color combinations even when they are displayed in the same size. Therefore, areas of the map covered by the icons are relatively small and the user can easily read the map.

The icons may be displayed in different sizes and colors when points of interest in the same kind are not densely located in the displayed area. The colors of the icons are specified by the additional information attributes. The icons may be displayed at different brightness. The icons may be displayed at different flashing speeds, for example, the icons may be constantly displayed, at a low flashing speed, or a high flashing speed. The additional information attributes, namely, the display attributes can be determined to specify different display conditions of the icons.

In the above embodiment, the icons indicating the points of interest having the small or the medium additional information values are not displayed at a predetermined scale at which only the icons indicating the points of interest having the large additional information values even in a condition that allows to display those icons. Furthermore, no icons are displayed if only the points of interest having the small additional information values exist in the area.

To solve such a problem, steps S310 through S330 shown in FIG. 7B are performed instead of steps S250 and S260 shown in FIG. 6. The control unit 29 determines whether the number of the icons for display is smaller than a reference value (S310). The reference value is predetermined based on experiments for determining the number of the icons that may reduce the viewability of the displayed map.

If the number of the icons is equal to or larger than the reference value (no at step S310), the control unit 29 determines whether reduction of the number of the icons is possible (S320). More specifically, the control unit 29 determines whether it is possible based on whether multiple levels of the additional information values of the points of interest for display are present. For example, the large, the medium, and the small additional information values may be present or two of combinations of the large and the medium additional information values, the medium and the small additional information values, and the large and the small additional information values.

If the reduction is possible (yes at step S320), the control unit 29 performs a process for reducing the number of the icons (S330). If the small additional information value is present, the control unit 29 excludes the icon corresponding to the small additional information value from the icons for display. If the small additional information value is not present, the control unit 29 excludes the icon corresponding to the medium additional information value from the icons for display. The control unit 29 repeats steps S310 through S330 until the number of the icons becomes less than the reference value (yes at step S310) and proceeds to step S270. If the numbers of the icons for display is smaller than the reference value without the reduction process, the control unit 29 also proceeds to step S270.

If the number of the icons is equal to or larger than the reference value (no at step S310) but the reduction of the icons is not possible (no at step S320), the control unit 29 proceeds to step S270. The reduction of the icons is not possible when the additional information values of the points of interest for display are all the same. In such a case, the control unit 29 cannot perform the reduction process, and therefore displays all appropriate icons even when the number of the icons is equal to or larger than the reference value.

If eight large values, five medium values, and seven small values exist and the reference value is 15, the total number of the additional information values is 20, which is larger than the reference value (no at step S310). Therefore, the control unit 29 performs the reduction process to exclude the icons indicating the points of interest having the small additional information values (S330). The total number of the large and the medium additional information values is 13, which is smaller than the reference value (yes at step S310). Thus, the control unit 29 stops performing the reduction process, and proceeds to step S270.

If the reference value is 10, the total number of the large and the medium additional information values is larger than the reference value (no at step S310). Therefore, the control unit 29 performs the reduction process to exclude the icons indicating the points of interest having the medium additional values. The total number of the additional information values becomes 8, which is smaller than the reference value (yes at step S310). The icons are more properly displayed according to the actual situation after selected with the above-described method than a method for selecting the icons according to map scales.

The present invention should not be limited to the embodiment previously discussed and shown in the figures, but may be implemented in various ways without departing from the spirit of the invention. For example, the updated map data may be stored in the external memory 28 and used for next map data update. With this configuration, the map data update process will not be performed for areas, the map data of which is already updated, and therefore the processing load can be reduced.

The entire map data may be updated and stored. In this case, a large-capacity storage, such as a hard disk drive, may be provided and the entire map data loaded from the CD-ROM is stored in the hard disk drive. The entire map data is up dated when new map data is received. With this configuration, the latest map data is available when the map display process is performed. Thus, the map data update process is not necessary when the map display process is performed. The present invention can be applied to electronic devices having map display functions other than vehicle navigation systems.

The additional information values can be determined based on whether the points of interest are chain stores. The control unit 29 may select multiple categories for determining the additional information values and assign multiple additional information attributes for indicating the multiple categories. For example, the sizes or the capacities, the years since opening or renovations, the evaluations by the third party are indicated by different sizes of the icons, different colors of the icons, and different flashing speed of the icons, respectively.

1. An electronic device having a map display function comprising:
data storing means that stores map data and points of interest data that is data on points of interest exist in an area of a map; and
display control means that performs control for displaying a map and marks indicating points of interest based on the map data and the points of interest data read from the data storing means, wherein
the points of interest data includes priority information indicating priority levels of points of interest in a kind for display, and
the display control means alters display attributes of the points of interest so that the marks of the points of interest are displayed in a manner that differences in the priority levels are noticeable.

2. The electronic device according to claim 1, wherein the priority levels are determined based on at least scales of the points of interest.

3. The electronic device according to claim 1, wherein the priority levels are determined based on at least price rating of the points of interest.

4. The electronic device according to claim 1, wherein the priority levels are determined based on at least a number of years since opening or renovation of the points of interest.

5. The electronic device according to claim 1, wherein the priority levels are determined based on at least evaluations of the points of interest by a third party.

6. The electronic device according to claim 1, wherein the display attributes specify at least sizes of the marks.

7. The electronic device according to claim 1, wherein the display attributes specify at least colors of the marks.

8. The electronic device according to claim 1, wherein:
the display control means performs control for displaying the map at different scales; and
the display control means performs control for displaying the marks such that a display size of the marks becomes relatively smaller as the scale becomes smaller.

9. The electronic device according to claim 1, wherein the display control means excludes the marks of the points of interest having lower priority levels when a number of the marks for display at a time is larger than a predetermined reference value.

10. The electronic device according to claim 1, wherein the display control means determines the priority levels of the points of interest for display according to the scale of the map, and performs control for displaying the marks of the points of interest having the determined priority levels.

11. The electronic device according to claim 10, further comprising relational storage means that stores relationships between the priority levels and kinds of the points of interest, wherein the display control means determines the priority levels of the points of interest for display according to the scale of the map based on the relationships stored in the relational storage means.

12. A vehicle navigation system comprising:
display means for displaying a map and marks indicating points of interest exist in an area of the map;
data storing means that stores map data and points of interest data that is data on the points of interest; and
display control means that performs control for displaying the map and the marks based on the map data and the points of interest data read from the data storing means, wherein
the points of interest data includes priority information indicating priority levels of points of interest in a kind for display, and
the display control means alters display attributes of the points of interest so that the marks of the points of interest are displayed in a manner that the priority levels are noticeable.

13. A program for displaying a map and marks indicating points of interest on a display comprising:
reading map data including data on maps and points of interest data including data on the points of interest that exist in areas of the maps from a data storing means;
obtaining priority information indicating priority levels of the points of interest in a kind; and
altering attributes of the points of interest so that the marks are displayed in a manner that the priority levels are noticeable.

14. The program according to claim 13, wherein the priority information indicates the priority levels determined based on at least sizes of the points of interest.

15. The program according to claim 13, wherein the priority information indicates the priority levels determined based on at least price rating of the points of interest.

16. The program according to claim 13, wherein the priority information indicates the priority levels determined based on at least a number of years since opening or renovation of the points of interest.

17. The program according to claim 13, wherein the priority information indicates the priority levels determined based on at least evaluations of the points of interest by a third party.

18. The program according to claim 13, wherein the display attributes specify at least sizes of the marks.

19. The program according to claim 13, wherein the display attributes specify at least colors of the marks.

20. The program according to claim 13, further comprising:
altering a scale of the map; and
displaying the marks such that a display size of the marks becomes relatively smaller as the scale becomes smaller.

21. The program according to claim 13, further comprising:
determining whether a number of the marks for display at a time is larger than a predetermined reference value; and
excluding the marks of the points of interest having lower priority levels when the number is larger than the predetermined reference value.

22. The program according to claim 13, further comprising:
determining the priority levels of the points of interest for display according to the scale of the map; and
displaying the marks of the points of interest having the determined priority levels.

23. The electronic device according to claim 22, further comprising
storing data on relationships between the priority levels and kinds of the points of interest; and
determining the priority levels of the points of interest for display according to the scale of the map based on the stored data on the relationships
